(19) United States
(12) Patent Application Publication
(10) Pub. No.: US 2009/0214283 A1
(43) Pub. Date: Aug. 27, 2009

(54) DEVICE FOR PACKAGING AND DISPENSING A PRODUCT

(75) Inventor: Laure THIEBAUT, Clichy (FR)

Correspondence Address: OBLON, SPIVAK, MCCLELLAND MAIER & NEUSTADT, P.C., 1940 DUKE STREET, ALEXANDRIA, VA, 22314, US

(73) Assignee: L'OREAL, Paris (FR)

(21) Appl. No.: 12/393,667

(22) Filed: Feb. 26, 2009

Related U.S. Application Data
(60) Provisional application No. 61/034,507, filed on Mar. 7, 2008.

(30) Foreign Application Priority Data
Feb. 26, 2008 (FR) 08 51203

(51) Int. Cl. B43K 24/00; B65B 5/00

(52) U.S. Cl. 401/53; 53/235

(57) ABSTRACT

A Device for packaging and applying a product over a bodily application surface is provided. The device includes a dispenser opening and projecting elements that are distinct from the product. The projecting elements extend into the dispenser opening and are positioned at a distance from a rim that delimits the dispenser opening.

### CROSS REFERENCE TO RELATED APPLICATIONS:

This document claims priority to French Application Number 08 51203, filed Feb. 26, 2008, and U.S. Provisional Application No. 61/034,507, filed Mar. 7, 2008, the entire contents of which are hereby incorporated by reference.

### FIELD OF THE INVENTION

The present invention relates to a device for packaging and applying a product, including cosmetic and care products. In a preferred, but not exclusive, example, the invention can be advantageously used for the application of a cosmetic product in tablet or block form, more commonly called a stick.

### BACKGROUND OF THE INVENTION

### Discussion of the Background

The expression “Cosmetic product” is understood to mean a product such as defined in Council Directive 93/35/CEE of 14 Jun. 1993.

Exemplary devices in the background art are described in, for example, German Patent Publication DE 3704936, French Patent Publication FR 26 32834, French Patent Publication FR 27 27608, French Patent Publication FR 28 65196, French Patent Publication FR 28 88735, French Patent Publication FR 28 92901, Great Britain Patent Publication GB 2159045, U.S. Pat. No. 2,007,245, U.S. Pat. No. 5,937,864 and PCT Publication No. WO2007/066764.

French Patent Publication FR 26 32834 describes an applicator for a liquid cosmetic preparation for hair that includes a container provided with a feeder element for the preparation. The feeder element includes a polyurethane foam that contains the preparation. The container includes an open end in which a close-fitting mounting part is inserted. The mounting part is passed through on both sides by a plurality of bundles of fibers. A rear end of the bundles is inserted into the feeder element. The preparation contained in the feeder element can then be spread by capillary effect. A cap in the form of a comb is also mounted on this container such that the teeth constituting a comb are positioned adjacent and parallel to the front ends of the bundles of fibers. In this case the comb is also positioned adjacent to the dispenser orifices.

However, a drawback linked with the device described in French Patent Publication FR 26 32834 is that it includes numerous parts to be assembled, and is therefore difficult to assemble and results in a high production cost. In addition, it is not convenient to use.

Document GB 2159045 describes a device for applying a fluid, paste or powder-form product. The applicator includes a product container that includes an open end topped with an application nozzle. The nozzle includes a central dispenser channel that is adapted to communicate with the container and around which an absorbent material extends, and in which or around which a plurality of spreading elements are provided.

However, a drawback linked with such a device is that it does not permit delicate and precise application of the product onto a given application surface.

U.S. Pat. No. 5,937,864 describes a hair-colouring device that includes a cluster of bristles that stand up from an open end of a chamber that contains a liquid formulation. However, a drawback linked with such a device is that it is poorly suited to separating or untangling keratinous fibers, in particular eyelashes.

### SUMMARY OF THE INVENTION

It is therefore one of the objects of the present invention provide a device that overcomes at least one of the aforementioned drawbacks.

It is also an object of the present invention to provide a device having novel body movements in use.

Another object of the present invention is to provide a device that is simple to manufacture, simple to use and of reduced production cost.

Another object of the present invention is also to provide a device that can obtain delicate and careful making-up or treatment of keratinous fibers.

It is also an object of the present invention to provide a device that enables sufficient loading of an application surface to be made-up or treated.

The subject of the present invention is a device for packaging and applying a cosmetic product, including care products, such as mascara over a bodily application surface, such as keratinous fibers, and in particular eyelashes or hair. An example of an embodiment includes a dispenser opening and projecting elements that are distinct from the product. In this example, the projecting elements extend into the dispenser opening and at a distance from a rim delimiting that delimits the dispenser opening.

In the present example, the projecting elements extend through the dispenser opening. Such elements thus extend on both sides of the rim delimiting the dispenser opening, and in particular on both sides of a mean plane passing through this rim or tangential to this rim. These elements can, fro example, project relative to the rim defining the dispenser opening at a height of around 3 mm, or, for example, 5 mm. Such a plane may, as appropriate, be transverse to an extension axis of the device. These projecting elements thus face the opening and are inscribed in this opening. In addition, at least one part of the projecting elements extends without contact with the rim defining the dispenser opening. Such a configuration may, in particular, be observed by looking at the device in a view from above or by producing an orthogonal projection of the projecting elements and of the free rim defining the dispenser opening onto a projection plane.

The projecting elements in the present example are different from reliefs formed from the surface of the product. Such elements are fitted in the product. These projecting elements can be made of a material that is, for example, impermeable to the product. They can, for example, be made of a thermoplastic material such as a polyolefin, an acrylonitrile-butadiene-styrene copolymer, more commonly called ABS, a polyamide, etc.

The projecting elements in the present example may be combing elements capable of separating, or even untangling, keratinous fibers, or they may be massage elements configured to massage a skin surface such as the face, the scalp, the torso, the back, the arms, the legs, the feet or the buttocks at several points. For example, such projecting elements can be distributed in such a way that the keratinous fibers are able to penetrate between them so as to apply make-up correctly to, and over the entire length of, the fiber(s) situated between the elements. These projecting elements, with a minimum number of two, or even three, four, five, six, seven, eight, nine, ten, or more, can be externally covered with the product over at least part of their height. More generally, the number of projecting elements can be, for example, between 2 and 20. This number can, in general, be less than 30. The elements in the present example can be designed to ensure combing from a first use of the product. In addition, in the present example, the elements can be designed to ensure this combing through approximately the entire lifetime of the product. In another exemplary aspect, the device includes a position in which the projecting elements and the product project relative to the rim delimiting the dispenser opening.

In the present example, in use, the projecting elements are able to open into the product, i.e. emerge from the product, so as to project relative to the dispenser opening, or where appropriate relative to a free external surface of the product. At least part of the height of the projecting elements can be externally covered with the product. If appropriate, the entire circumference of the projecting elements is in contact with the product. Thus at least part of the projecting elements may extend into the product. These projecting elements are able to project relative to an upper portion defined by the product. This upper portion can be provided opposite a base unit of the device. In other words, it can also be provided opposite a lower portion in contact with the support of the product.

These projecting elements can be surrounded by the product over at least 30% of their height. Such projecting elements can be internally full or empty of product. In a variant, they can be passed through by a dispenser channel opening onto a dispenser orifice with a surface area strictly less than the surface area of the dispenser opening. The dispenser orifice can, for example, extend over a surface area, especially a transverse or radial surface area, that is at least twice, five times, ten times, a hundred times or more, smaller than that of the dispenser opening.

In the present example, the device can include a base unit, the projecting elements being joined to the base unit. This base unit may at least partly define a container for the product. Such a base unit may define a surface accessible to the user with a view to its being gripped. In particular, these projecting elements can be joined to a gripping element or to a shaft, the shaft possibly being in contact with the product to be applied. At least part of the projecting elements may extend to an invariable, or constant, height relative to the dispenser opening, and more precisely to the rim delimiting this opening.

The device can also include a support for the product. The support can be fixed or be able to be moved relative to the base unit. Such a base unit can, for example, extend at least partly below the product to be distributed when the device is placed on a rest surface. If appropriate, this base unit or a part associated with this base unit can support the product.

In the present example, the projecting elements can be fixed relative to the device. For example, the projecting elements can be fixed relative to the base unit. The product itself may be movable relative to the projecting elements.

The projecting elements can extend from or through a product support and, for example, through openings formed in this product support. In another exemplary aspect, the projecting elements can include protuberances. For example, such elements can have the form of tapered teeth and in particular of thin wedges with a rounded free end, of thin strips or rods with very small balls at the ends. These projecting elements can be of identical or different configuration. The projecting elements can be distributed at regular or variable intervals. For example, two consecutive projecting elements can be spaced a minimum of 0.5 mm and a maximum of 20 mm apart.

In the present example, the projecting elements include a first fixed end, called the base unit end, connected to a base unit and a second free end. The projecting elements can be of constant or variable height. For example, the height of the projecting elements between the fixed end and the second free end can be, for example, between 1 mm and 100 mm. The relative height of these elements relative to the total height of the device can be between 0.1 and 3.

The projecting elements can be produced in a single piece with the base unit. In a variant they may be fitted in corresponding housings, for example provided in the base unit. In such a case, they may be fixed in these housings by any appropriate means such as tight-fitting, screwing, snap-fitting, bonding, soldering, etc. The projecting elements can be made of a material identical to or different from that of the base unit. In the latter case, the base unit may, for example, be made of a polyolefin, an ABS or a polyamide while the projecting elements may be made of elastomer or of a plastic coated with a flocking.

The projecting elements can have a cross section with a shape that is, for example, circular, elliptical, polygonal such as triangular, square, rectangular, trapezoidal, rhomboidal, etc. In one example embodiment, these elements have a conical form of circular cross section. At least one among the projecting elements, if appropriate a plurality, or even all the elements, can have a cross section of size between 0.5 mm and 5 mm, for example, around 1 mm, at its base unit. At its free end, this cross section may have a size of between 0.2 mm and 2 mm, for example, around 0.3 mm. Thus in general terms a cross section of a projecting element can be, for example at least 10, or even 20, times smaller at its base unit in relation to the surface area of the dispenser opening. Moreover, a cross section of a projecting element can be at least 100, or even 1000, times smaller at its free end in relation to the surface area of the dispenser opening. The projecting elements may be arranged, at the level of their base unit and/or their free end, in a row of generally straight or curvilinear profile. For example, at least 30%, 50%, 80% or even approximately 100% of the projecting elements can extend in a common plane. Alternatively, at least part of the projecting elements may extend circumferentially around a circular arc.

The product to be distributed can, for example, be a make-up product. Thus this product can, for example, be a mascara, a lipstick, a lip-gloss, a nail varnish, a face powder, an eye shadow or an eyeliner. The product to be distributed can also be, for example, a keratin care or a hair shaping product such as a shampoo, a coloring product, a conditioner or a styling agent. A “styling agent” is understood to mean any ingredient of a hair composition, in particular any polymer, having the function of providing a body of hair with cohesion by depositing a material limiting its relative movement. The product to be distributed can also be a body-care product such as an anti-wrinkle cream, a concealer, an oil or a deodorant.

The product to be distributed can be, for example, in stick form. A stick is understood to be a product that preserves its predetermined shape in the absence of stress, at ambient temperature and at atmospheric pressure. A product packed in stick form is self-supporting, preferably for at least 60 seconds. Such sticks are generally obtained by hot-pouring the product or else by extrusion. Advantageously, the product stick can be a solid compound, in particular a compound that is dry-crumbleable. “Dry-crumbleable” refers to a compound capable, at ambient temperature, of forming a deposit that adheres to and coats a substrate, particularly keratinous fibers, and more particularly eyelashes, when they are respectively placed in direct contact with one another, without requiring prior preparation, and in this instance without requiring prior contact of the compound with an aqueous phase. Such dry-crumbleable products contrast with mascaras in tablets that are water-crumbleable and must first be partially dissolved in order to be applied on the keratinous fibers and to form a deposit that adheres and coats. The dry-crumbleable compound according to the invention can be removed, transferred and spread.

For example, the product stick can be a solid compound having a hardness of between 500 and 18,200 Pa, between 900 and 10,000 Pa, or, for example between 1,800 and 8,200 Pa. Such a hardness makes it possible to obtain a compound that is sufficiently rigid to have the shape of a stick while having a sufficiently “soft” texture to allow straightforward application on the eyelashes, particularly a deposition of material by being brought into direct contact with the eyelashes without exerting pressure on the fringe of eyelashes. The method used to determine the hardness of a cosmetic compound according to the invention is that known as the “cheese wire” method. To this end, a stick of the compound whose hardness is to be determined is prepared. The stick is obtained by pouring a compound into an aluminium mould placed for 45 minutes at −28° C., then turned out of the mould and packaged in an article of packaging, in particular a pen, and then kept at a temperature of 20° C. for 24 hours prior to the measurement. A rigid wire of 250 μm diameter made of tungsten is advanced relative to the stick at a speed of 100 mm/min so as to cut the stick transversely using the wire. The measured hardness corresponds to the maximum shearing force exerted by the wire on the stick at 20° C., this force being measured by means of a DFGS2 dynamometer marketed by the company INDELCO-CHATILLON. The measurement is repeated 6 times. The mean of the 6 values read by means of the aforementioned dynamometer, denoted Y, is given in grams. This mean is converted into pascals by the following equation to obtain the hardness value of the stick:

(Y×10⁻³×9.8)/surface area of the cross section of the stick (in m²)

In the case of a cylindrical stick of circular section, the area of the cross section is equal to π×R², R being the radius of the stick expressed in meters.

The hardness of the compounds according to the present invention is preferably such that the compounds are self-supporting and can furthermore be easily broken up to form a deposit on the surface of the keratinous fibers when they are brought into contact with them.

Cosmetic compounds such as those described, for example, in documents FR-2 881 343, FR-2 895 248 or FR-2 895 252 may, for example, be employed in a device according to the invention.

For example, the product stick may have the shape of a baton including a longitudinal axis. This stick can include a tubular portion, and in particular a cylindrical portion. The product stick can for example have a cross section with a shape that is circular, elliptical, oblong, polygonal etc. For example, the stick can have an internal cross section having a portion that is inwardly concave and a portion that is inwardly convex with an identical or different radius of curvature. For example, the radius of curvature of the portion that is inwardly concave can be greater than that of the portion that is inwardly convex, or vice versa. The product stick can also have a cross section with a ring section of circular profile. More precisely, this stick can have a half-ring shape. The stick can also include two inwardly concave portions. In a variant the stick can include two inwardly convex portions. Alternatively, the stick can include two inwardly convex portions respectively facing two inwardly convex portions of the gripping element.

This product can define a free external surface surrounding the projecting elements and suited to being brought directly into contact with the application surface. This free external surface of the product is capable of extending in a projecting position relative to the dispenser opening, i.e. relative to the free rim delimiting the dispenser opening. In this stable state, or position, of the device, the projecting elements and a free external surface of the product are able almost simultaneously to come into contact with a keratinous application surface to be made-up or treated. More precisely, the device can be configured so that the product situated in a space separating two projecting elements is capable, together with the two projecting elements, of simultaneously coming directly into contact with the keratinous application surface to be made-up or to be treated.

In the present example, the projecting elements can include a free end flush, or even projecting, relative to the dispenser opening, or if appropriate relative to a free external surface of the product. The projecting elements can include a first end associated with the base unit and a second free end, the first and second ends possibly being connected to each other via an intermediate portion extending at least partly into the product. Some or all of the projecting elements can point in the same direction, in particular in a direction of product distribution. These projecting elements can completely or partly extend in the same direction. At least one part of the projecting elements extends in a direction approximately coinciding with an axis extending the container. They may extend parallel or obliquely relative to an axis of translation of a product support. They may be distributed circumferentially over a product support with, if appropriate, the free ends pointing in identical or different directions.

At least part of the projecting elements can open out approximately at the centre of the dispenser opening. The relative level between the projecting elements and the product can optionally be adjustable. Thus according to a first variation in use, the user can optionally apply the product alone to herself when the product is positioned beyond the free ends of the projecting elements. According to a second variation in use, she will be able to comb the application surface before depositing the product by placing the external surface of the product stick below the surface of the free ends of the projecting elements. Finally, according to a third variation in use, the combing of the application surface and the application of the product may be carried out simultaneously.

According to a first example embodiment, this device for packaging and applying a cosmetic product can include a product support, in the form of, for example, a plate, a shaft forming a housing for the product and a driving means or driving arrangement configured to cause translational movement of the plate in the shaft, the movement of the plate enabling the distribution of the product via a dispenser opening in the shaft, the shaft being mounted in a base unit. With such an arrangement, at least one of an external cross section of the base unit or an internal cross section of a lateral wall of the shaft includes an inwardly convex portion, the base unit and the shaft possibly being of non-homothetic section.

Thus, as an example, the driving means or driving arrangement can be included in the master section of the base unit and the device can be advantageously compact. For example, the lateral wall of the shaft can include an internal cross section having an inwardly concave portion and an inwardly convex portion, the base unit having an outwardly convex external cross section. The plate can be in sealed contact with the lateral wall of the shaft, in at least one position of the plate in the shaft. In particular, the plate is in sealed contact with the internal circumference of the lateral wall when it is in a low position in the shaft and when the product does not pass through the dispenser opening. This arrangement is especially advantageous when the packing of the device with the product is carried out via the dispenser opening.

In another exemplary aspect, the device can include a cap configured to cooperate with the base unit. For example, the cap can cooperate with a gripping element of the base unit. Thus, between two occasions of use, the product can be protected in the volume delimited by the shaft, the plate and the cap. Advantageously, the cap can ensure a sealed closure of the base unit, the product, the shaft and the plate being positioned inside this sealed volume.

In the present example, the driving means or driving arrangement may circumscribe the main cross section of the base unit. This arrangement encourages the compactness of the device. Advantageously, the driving means or driving arrangement can be positioned between the lateral wall of the shaft and the base unit. For example, the driving means or driving arrangement can be positioned between the area of the lateral wall having the inwardly convex portion and the base unit. The driving means or driving arrangement can be slid in a groove in the shaft. This groove can advantageously be produced through the lateral wall in an axial portion of this wall surrounded by the base unit. Thus the groove is concealed by the base unit.

In addition, in an example in which the driving means or driving arrangement includes a push button, the latter passes longitudinally beyond the base unit, the driving means or driving arrangement includes a longitudinal portion extending into the base unit and having a spur passing through the groove. In this example, the groove can be formed in a longitudinal portion of the shaft at a distance from the longitudinal portion in which the plate can be moved. To this end, the spur of the driving means or driving arrangement can cooperate with a distal end of a rod sticking out from a base of the plate, the rod extending in the shaft in the direction of a base of the base unit. The push button can include a free end positioned approximately at the level of the plate, the groove being configured to permit movement of the plate through to the level of the opening in the shaft. When the plate is in the high position and the plate is situated approximately at the level of the dispenser opening, the free end of the push button is situated around the dispenser opening without passing beyond the level in which it extends.

The groove can include two axial stops so as to determine the maximum axial travel tolerated for the plate. This distance between the two axial stops corresponds approximately to the height of the product which is, for example, positioned on the plate. For example, a ratio of the height of the product before the first use to the total height of the device may be between 0.3 and 0.8, and preferably between 0.4 and 0.6, advantageously around 0.5. In another example, the driving means or driving arrangement may be mounted to be rotationally mobile, if appropriate relative to the shaft, and thus form a thumbwheel.

The product support can include a plate forming a seat for receiving the product which may be in stick form. This plate can have openings. In other words, it can be permeable to the product, especially when the product positioned on this plate is in stick form and when it has been deposited by hot-pouring, the solidification of the stick taking place in situ in the shaft. In this example, the shaft advantageously includes a second opening axially opposite the first opening so as to allow the product to pour into the housing. The device is then presented “head down” beneath the product injection means.

The dispenser opening in the shaft can be blocked before the first use. This arrangement is especially useful when the product is poured into its housing from an opening opposite the dispenser opening. In order to block this dispenser opening there is, for example, a protective cap. In the case in which the protective cap is rigid, it also allows shaping of a free end of the poured product.

In a first example embodiment in which the projecting elements are joined to the gripping element of the base unit, once the product has been poured, the projecting elements can be introduced through the opening opposite the dispenser opening. These projecting elements can then extend through the orifices of the product support and come into contact with the product. These elements can then go through the product so as optionally to project relative to a free external surface of the product. So as to position the projecting elements correctly, positioning means, or indexing means, can be provided. Such positioning means can, for example, include housings or recesses formed in the obturator and in which the projecting elements will respectively be able to be positioned. At the end of the travel of the gripping element, the opening opposite the dispenser opening will be blocked by this gripping element. The obturator is initially placed opposite the dispenser opening during pouring may then be removed, in particular once the product has cooled correctly and, if necessary, solidified.

In a second example embodiment in which the projecting elements are joined to the shaft of the base unit, the product poured through the opening opposite the dispenser opening will pass through the orifices of the product support then position themselves around the projecting elements. The gripping element can then be positioned in order to block the opening. In this example, the obturator initially placed opposite the dispenser opening during pouring may be removed. Here again positioning means, for example similar to those previously described, can be employed.

The shaft can open out in the direction of its dispenser opening. The internal lateral wall of the shaft is thus easier to remove from the mould. In this example, as soon as the plate is moved from its initial position, a space is created between the external circumference of the plate and the internal circumference of the lateral wall. The movement may then be effected without being prevented by friction stresses. The product can in addition more easily come away from the walls.

In one example, the dispenser opening in the shaft can have an internal circumferential section approximately identical to that of the internal cross section of the shaft. It then has an inwardly concave portion and an inwardly convex portion. The product presented on the plate is thus moved through the dispenser opening without being changed by the latter. If it is presented in the form of a tablet, the distributed product then also has a concave portion and a convex portion. This form of opening for the product distribution is in particular suited for coming into contact with a fringe of eyelashes. Indeed, as the eyelashes are implanted at the edge of the eyelid, with this eyelid following the shape of the eyeball, the base of the eyelashes thus lies on a curve. With such a shape of opening, it is thus possible to coat a row of eyelashes by coating them with the product from approximately the same point relative to their respective base. The application of make-up is thus uniform.

Separation/combing elements can extend parallel to an axis extending the device and optionally parallel to an axis of translation of the plate in the shaft. In one example, they are configured so as to engage with the keratinous fibers in order to separate/comb them at the same time as and/or after application of the product on the fibers by means of the distributed product at the dispenser opening. The separation/combing elements can be, advantageously, tapered, in the form of teeth or of bristles, in order to enable combing and/or effective separation of keratinous fibers and in particular of eyelashes.

The inwardly concave portion and the inwardly convex portion can be approximately superposable and positioned opposite each other in such a way that the dispenser opening forms a curved slot. Such an arrangement enables, for example, conformity with the implantation of a fringe of eyelashes at the edge of an eyelid.

According to an example method of applying a product on the eyelashes by means of a device according to the invention, the device is moved along a path defined in the same plane approximately perpendicular to the cornea and parallel to the plane of the nose. This path is in particular that of the dispenser orifice which is then brought, tangentially to the cornea, into contact with the base of a row of eyelashes, the dispenser orifice then being moved along the row of eyelashes in the direction of their respective free end, forcing the eyelashes against the dispenser opening. The movement of the device can be made in an iterative loop defined in one or more plane(s) approximately perpendicular to the cornea and parallel to the plane of the nose, depending on the make-up effect sought.

According to another example embodiment, the packaging and application device can include a gripping element, a stick of at least one cosmetic product, a frame fixed relative to the product and extending into the latter, the stick defining a free external surface extending over at least a portion of the height of the frame, and a cap arranged to fasten onto the gripping element and cover the stick. “Free external surface” should be understood as a surface without contact with a wall covering it during use of the device. The stick can be formed of a single product or, in a variant, include two, or even more, different products. One of the products may be colored and the other intended to add sheen. The two products can respectively be positioned on either side of a median plane for the frame. This median plane can have the projecting elements. Such a product can be applied without any constraint other than removing the protective cap.

In one example, the frame can be fixed in relation to the gripping element. The frame contributes to holding the product mechanically, which permits new possibilities in terms of formulation. For example, it enables use of a relatively fragile product without worrying that the product will break on use. Such a frame can be flat or not flat, for example cylindrical or rippled. A flat form can provide the frame with flexibility, for example. The frame can include openings and/or include reliefs encouraging the fixing of the product on the frame. For example, the frame can include a plurality of holes that are passed through by the product. The frame can come from single-piece molding with the gripping element, for example in a thermoplastic material such as a polyolefin. The frame can be arranged so as not to make contact with the cap while the latter is in place on the base unit, and, for example, when the cap is in place on the gripping element of the base unit. In a variant example, the frame may come into contact with the cap when the latter is in place on the base unit, which for example makes it possible, if necessary, to prevent the products from mixing.

The base unit can include a filling opening on the side opposite the cap. The device can include a removable or nonremovable stopping element fixed in the filling opening. The base unit can include, over at least a portion of its height, an oblong external cross section, but other shapes are conceivable.

The cap can be constructed so as to rest in a stable manner upside down on a plane horizontal surface. This may simplify reshaping the stick. In a variant example, the device can include a stand independent of the cap on which the cap may be placed upside down in a stable manner.

In one example, the product stick can advantageously be fluidized by applying heat. The product can have, for example, a melting point less than or equal to 60° C. A manufacturing method for such a device can include the steps of positioning the cap upside down and in place on the base unit, at least one product being poured in the fluid state through the filling opening in the base unit, and in particular in the gripping element of the base unit, the cap serving as a mould to give the product its shape during cooling. A method for reshaping a stick of at least one product of a device as defined above can include the steps of positioning the cap upside down and in place on the base unit, and heating the product in order to bring it to a temperature at which it becomes fluid, so that on cooling the product takes on the shape of the cap. The heating can be carried out, for example, by placing the device in a microwave oven.

### BRIEF DESCRIPTION OF THE DRAWINGS

The invention will be better understood on reading the following detailed description, given with reference to the accompanying drawings illustrating a non-limiting examples thereof, wherein:

FIG. 1 is a side view, in perspective, of a first example embodiment of a device according to the invention with a mounted cover;

FIG. 2 is a side view, in perspective, of an example of a device according to the invention, the push button being in the low position;

FIG. 3 is a view from above from the dispenser opening of the example device of FIG. 2;

FIG. 4 is a side view, in perspective, of an example of a device according to the invention, the push button being in the mid-position;

FIGS. 5 and 6 are exploded perspective views of a device according to the invention;

FIGS. 7 and 8 are longitudinal section views of example variant embodiments of a device according to the invention in the process of being filled;

FIG. 9 is a perspective view of an example embodiment of a product support from an example of a device according to the invention;

FIG. 10 is a view of an example of a device according to the invention as it is being used;

FIGS. 11 to 15 are schematic views from above from an example of the dispenser opening of example variant embodiments of a device according to the invention;

FIG. 16 is a view from above of an example variant embodiment of FIG. 3;

FIG. 17 is a perspective view from above of an example variant embodiment of an example of a device according to the invention;

FIG. 18 is a perspective view from below of the example variant embodiment shown in FIG. 17;

FIG. 19 is a longitudinal section view of the example variant embodiment shown in FIG. 17;

FIG. 20 is an exploded perspective view of an example of a device according to the invention integrating the example variant embodiment of FIG. 17;

FIG. 21 is a perspective view, slightly from the side and slightly from above, of another example embodiment of a product support for a device according to the invention;

FIG. 22 is a perspective view from above of the example product support shown in FIG. 21;

FIG. 23 schematically shows in longitudinal section a second example embodiment of a device according to the invention;

FIG. 24 is a longitudinal section along II-II in FIG. 23;

FIG. 25 shows in isolation and in perspective an example of the gripping element and an example of the frame;

FIG. 26 is a perspective view of the example of the gripping element and of the example of the frame from a viewing angle different from that of FIG. 25;

FIG. 27 shows an example of the device closed, in a front view;

FIG. 28 shows an example of the device closed, in perspective;

FIG. 29 shows an example of the device after removing the cap;

FIG. 30 is a side view of an example of the device after removing the cap;

FIGS. 31 to 33 illustrate the appearance of an example of the product as it is consumed, in the example of reshaping the application surface;

FIG. 34 shows in section, isolated and partly, an example variant embodiment of the cap;

FIG. 35 illustrates the use of an example of a stand for putting the cap upside down;

FIG. 36 is a view similar to FIG. 30 of an example variant embodiment;

FIG. 37 is a partial longitudinal section of an example variant embodiment;

FIG. 38 is a view similar to FIG. 24 of an example variant embodiment;

FIG. 39 is a longitudinal section view of a third example embodiment of a device according to the invention;

FIG. 40 is a truncated perspective view of an example of the device shown in FIG. 39; and

FIG. 41 is a longitudinal section view similar to FIG. 39 of an example variant embodiment.

### DETAILED DESCRIPTION OF THE PREFERRED EMBODIMENTS

Referring now to the drawings, wherein like reference numerals designate identical or corresponding parts throughout the several views.

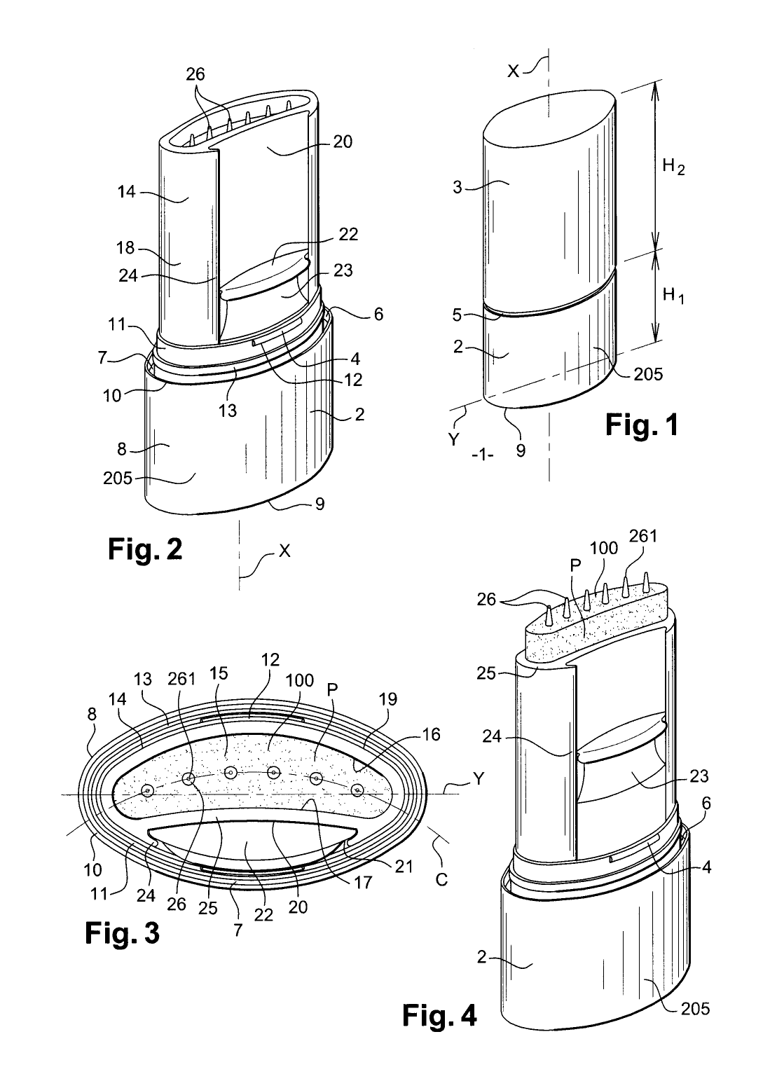

FIG. 1 shows a first example embodiment of a packaging and application device 1 according to an example of the invention. Such a device can include a base unit 2 on the one hand and a cap 3 on the other hand. This cap can be mounted on the base unit between a position covering the product and a disengaged position.

According to this example embodiment, the assembly including the device 1 and the cap 3 defines a cylinder whose generatrix corresponds in this example to an axis of translation X of the cap 3 relative to the base unit 2 during mounting of this cap 3 on the device 1. The cap 3 can include an upper wall from which a peripheral skirt extends. This cap, and in particular the upper wall, can include a mirror (not shown) intended to simplify the application of the product.

The base unit in the present example includes a gripping element 205. The cap 3, and in particular the peripheral skirt, may circumscribe the main cross section of the gripping element 205. In particular, a cross section at the X axis of the assembly has an outwardly convex outline, for example ovoid in shape. In particular, the cross section is elliptical with a major axis Y. Along the X axis, in the assembled position, the gripping element 205 has a height H1 and the cap a height H2. The ratio of the height H1 to the sum of the heights H1 and H2, corresponding approximately to the height of the assembly in the assembled position, is between 0.3 and 0.4 and preferably around ⅓. The height H1 preferably corresponds to the thickness of a thumb. This is because the gripping element is in the present example is configured to be held in a tight grip between two fingers, for example between the thumb and the index finger. H1 is, for example, between 1 and 3 centimeters, for example between 1.5 and 2 cm.

In the present example, in order to be able to apply the product contained in the application device 1, the user detaches the cap 3 from the base unit 2. The device 1 of the present example is then placed in the form presented in FIG. 2. The cap 3 is, for example, retained on the base unit, and in particular on the gripping element of the device, by snap-fitting means 4. As can be seen in FIGS. 1 and 2, the cap 3 include also include an annular lip 5 engaged by force in an annular space 6 defined by the gripping element. In the present example, the annular space 6 is defined at the level of an edge 7 of a lateral wall 8 of the gripping element. The lateral wall 8 is mounted on a base 9 defined transverse to the X axis. A first external annular skirt 10 is mounted on the edge 7. This skirt has an external circumference defined according to the generatrix of the external circumference of the cylindrical lateral wall 8. The annular space 6 is defined between this first external annular skirt 10 and a second internal annular skirt 11 extending according to the generatrix of the internal circumference of this cylindrical lateral wall 8.

In the present example, as can be seen in FIG. 2, the snap-fitting means 4 are presented in the form of a transverse ridge 12 projecting outwardly from the gripping element from the second internal annular skirt 11. To this end the second internal annular skirt 11 has a height along the X axis greater than that of the external annular skirt 10. Advantageously, the internal annular skirt 11 can include two transverse ridges such as 12, these two ridges advantageously extending approximately parallel to the major axis Y of the ellipse formed by the external circumference of the internal annular skirt 11. These snap-fitting means 4 can be configured to cooperate with a complementary relief provided on the inside of the cap 3. In this way the axial immobility of the cap 3 relative to the base unit 2 is obtained. In order to ensure the seal of the closing in the present example, as previously seen, the annular lip 5 is in tight contact between the internal circumference of the first external annular skirt 10 and an annular bead or snap ring 13 provided projecting from the second annular skirt 11 in the annular space 6.

In an example variant of the relief 4 as shown, a second annular bead or snap ring can be provided. In such a case, the cap can be without any relief. This double sealing band linked with the presence of two beads enables a good tight seal of the cap. The cap 3 assembled on the base unit 2 thus defines a sealed internal volume, static sealing being provided between these two parts. The product contained in the assembly is protected from the external environment.

In the present example, the base unit 2 also includes a shaft 14. This shaft is mounted inside the gripping element 205, the shaft 14 being fitted to the inside of this element. Such a shaft 14 therefore projects relative to the gripping element 205. This shaft 14 defines a housing for the product and includes a dispenser opening 15 axially opposite the base 9. In the example illustrated in FIG. 3, an internal cross section of the shaft 14, has a “bean” shape. For example, this internal cross section includes an inwardly concave portion 16 and an inwardly convex portion 17, FIG. 3. These concave 16 and convex 17 portions extend along a longer side of a cross section of the device. For example, these concave and convex portions generally extend along the major axis Y and in particular on both sides of this axis. The dispenser opening 15 then has a section approximately identical to that of the shaft 14. The portions 16 and 17 are, for example, opposite each other so that the dispenser opening forms a slot extending along a curve C.

In the present example, the portions 16 and 17 have different radii of curvature so that the width of the slot measured perpendicular to the curve C passes through a maximum in a median area at a distance from the ends of the portions 16 and 17. In the illustrated example, the inwardly concave portion 16 has a smaller radius than the inwardly convex portion 17, so that at the ends there is a small radius enabling the eyelashes in the corner of the eye to be made-up and so that at the centre there is a greater width to enable filling and to obtain a large volume of product.

As can be seen in the example illustrated in FIGS. 2 and 3, the shaft 14 is cylindrical and with a generatrix parallel to the X axis. A lateral wall 18 of this shaft has an external face having an outwardly convex profile 19 and an outwardly concave profile 20 corresponding to the concave 16 and convex 17 portions respectively. In this example, the lateral wall 18 has an approximately constant thickness. The outwardly convex profile 19 also extends approximately along the curve C. It is brought into contact with the internal circumference of the internal annular skirt 11. This curve C preferably extends along the major axis Y of the ellipse formed by the cross section of the gripping element 205. There is therefore a space 21 between the outwardly concave profile 20 and the internal circumference of the lateral wall 8.

In the present example, a driving means 22 is partly positioned in the space 21. The driving means 22 in this example includes a push button 23 housed in the space 21 and cooperating with a product support or plate positioned inside the shaft 14. In this configuration, a movement of the push button along the X axis enables a translation of the plate along the axis in the shaft 14 with so as to dispense the product via the dispenser orifice 15. The push button 23 circumscribes the main cross section of the gripping element 205 and even circumscribes the main cross section of the annular bead 13.

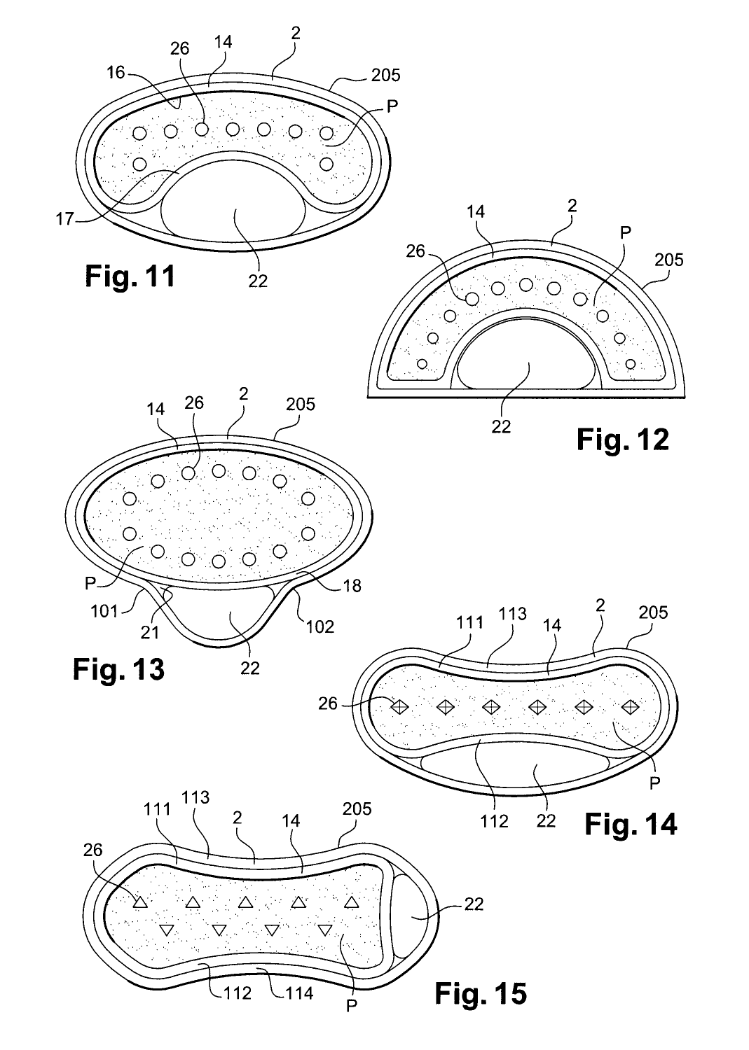

In an example variant, the inwardly concave portion 16 can have a radius of curvature that is identical with, and can therefore be superposed on, that of the inwardly convex portion 17. In another example variant illustrated in FIG. 11, the radius of curvature of the inwardly concave portion 16 can be greater than that of the inwardly convex portion 17. In another example variant illustrated in FIG. 12, the external circumference of the gripping element 205 defines a semicircle inside which the shaft 14 delimiting the housing for the product P is positioned. The internal and external circumference of the shaft 14 represents a half-ring.

In another example variant illustrated in FIG. 13, the shaft 14 has a profile that is completely inwardly concave and is mounted in a gripping element 205 having two outward concavities, respectively forming two inwardly convex portions 101 and 102. The driving means 22 is housed in this embodiment in the space 21 defined between the external circumference of the lateral wall 18 and the inward concavity defined by the wall 8 between the two convex portions 101 and 102. In another example variant illustrated in FIG. 14, the shaft 14 includes two inwardly convex portions 111 and 112 and the gripping element 205 has an inwardly convex portion 113. The convex portion 113 of the gripping element 205 is positioned facing the convex portion 111 of the shaft 14, the driving means 22 being positioned between the second convex portion 112 of the shaft 14 and the gripping element 205.

An example variant of FIG. 14 is illustrated in FIG. 15. In this example, the shaft 14 includes two inwardly convex portions 111 and 112 respectively facing two inwardly convex portions 113 and 114 of the gripping element 205. A space 21 is nevertheless provided between the wall 18 and the gripping element 205 in which the bulk of the driving means 22 may be placed.

In another example, the external cross section of the base unit is not homothetic with the internal cross section of the shaft 14.

In the present example of the invention, the device includes projecting elements 26 that extend into the dispenser opening 15. Some or, as shown, all of these elements extend a distance from a free rim or edge 25 delimiting the dispenser opening. These elements extend to a non-zero radial distance from the rim, for example between 1 mm and 20 mm. The projecting elements 26 can include teeth or wedges, for example. Such projecting elements can be, for example, conical. For example, they can have a circular base with a diameter of around 1 mm, and the diameter at the level of the free end can, in turn, be around 0.3 mm. Two consecutive projecting elements can be spaced about 1 mm apart from each other, for example.

These projecting elements can include a row of teeth. In an example variant, these projecting elements can include a plurality of rows of teeth, for example two, three or more in number. Such projecting elements can then be arranged aligned from one row to another. In another example variant, the projecting elements may be arranged offset or staggered.

By way of example, several possible arrangements of projecting elements are illustrated in FIGS. 11 to 15. In the example illustrated in FIG. 1I1 these elements are generally arranged in the product in the shape of an inverted “U” or horseshoe. In the example illustrated in FIG. 12 these elements are arranged in a curvilinear row or a circular arc. Such elements may have a cross section of size decreasing from the centre towards at least one, or even both, peripheral end(s) of the product, if appropriate along the curve C. In the example illustrated in FIG. 13 these elements are arranged in an oval. In these preceding three example embodiments, the projecting elements can, for example, have a cross section of circular shape. In the example illustrated in FIG. 14 these elements are arranged in a perfectly straight row. Such elements have, for example, a cross section of rhomboidal shape. In the example illustrated in FIG. 15 these elements are arranged in an alternately offset manner. In other words, these elements may be arranged in a plurality of rows, such as two rows, each row including a tooth element situated slanted relative to two elements from the other row. Such elements have, for example, a cross section of triangular shape. According to variants not shown, these elements might also be arranged in a circle or in a polygonal structure. Other cross section shapes might also be envisaged.

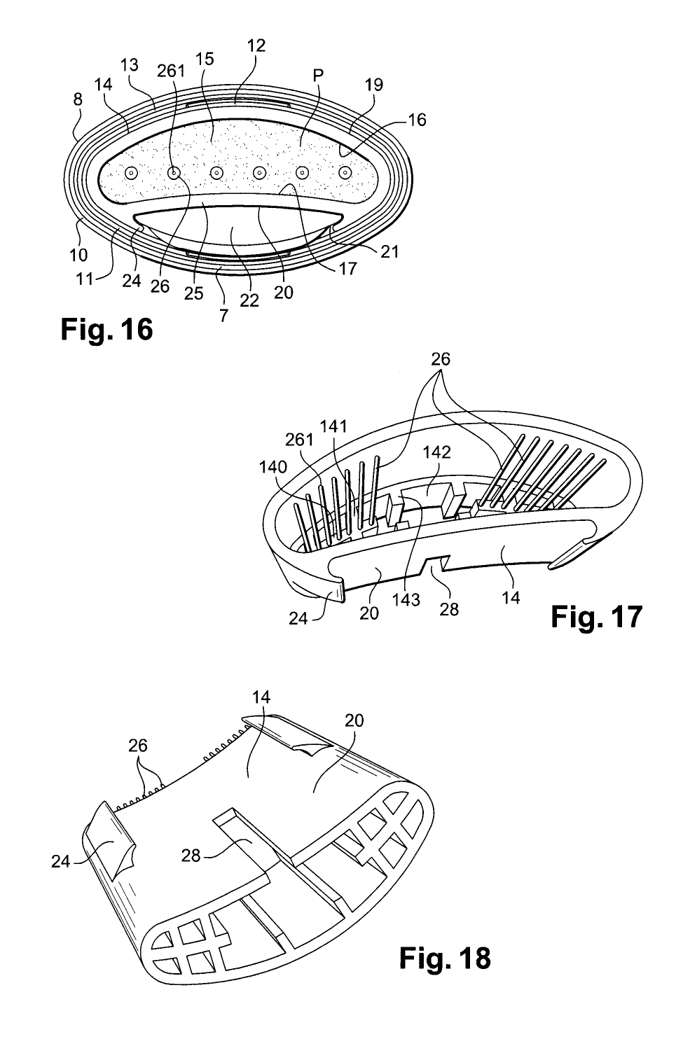

Each projecting element includes a free end 261 respectively able to project relative to a free external surface 100 of the product. A fictive line connecting the free ends of the projecting elements can have a curved profile, as shown in FIG. 3, or a straight profile, as shown in FIG. 16, for example. When the projecting elements are arranged in a curved arrangement, these free ends can define a circular arc, optionally coinciding with the curve C. This circular arc may, for example, have a radius of curvature greater than that of the portion 16 and less than that of the portion 17. This curve can stretch in a plane transverse to an axis extending the device.

In the present example, some or all of the projecting elements can be at least partly surrounded by the product in the state of use and optionally also in the state of non-use.

According to a first example embodiment, the projecting elements can extend from the gripping element 205 of the base unit 2. These elements can be produced in a single piece with the gripping element. In an example variant, they may be fitted in corresponding housings provided in the gripping element and fixed by any appropriate means such as tight-fitting, screwing, snap-fitting, bonding, soldering, etc. These projecting elements, when fitted, can optionally be made of a material different from that of the base unit.

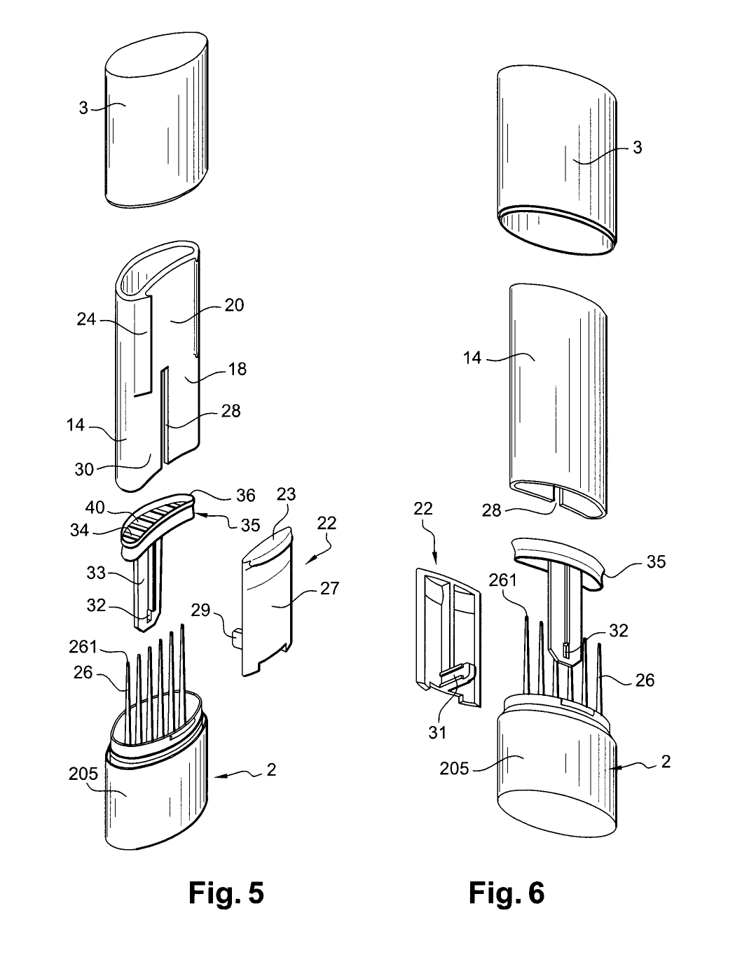

In the mounted position of the device, these projecting elements can extend through openings 40 formed in the product support (see, for example, FIG. 5). These elements can be positioned so that they extend over at least part of the height of the product, or even over at least the entire height of the product. In other words, these projecting elements can pass through the product over approximately its entire height. For example, these projecting elements can pass through the product at two opposite portions of this product. These two opposite portions can include a lower portion resting on the product support and an upper portion or tip intended to come into contact with the bodily application surface to be made-up or to be treated. When the device is placed on a rest surface, with the base unit and in particular the base of the gripping element bearing on this surface, the projecting elements can extend below, through and above the product. In other words, in the present example, these elements then extend inside the product so as to emerge flush with or even projecting from the product. At least part of the projecting elements can extend approximately parallel to an axis extending the device and, if appropriate, approximately parallel to the X axis.

According to a second example embodiment shown in FIGS. 17 to 20, the projecting elements 26 can extend from the shaft 14 of the base unit 2. In particular, these projecting elements can extend in the shaft. They can then stand up from a bar 140 extending from an internal wall of the shaft. This bar can optionally be connected to the shaft by one or more crosspieces 141. This bar, and if appropriate these crosspieces, can be produced in a single piece with the shaft. In an example variant, this bar 140 can be mounted on or across an open end of the shaft. The projecting elements 26 can be produced in a single piece with the bar alone or together with the shaft, or be fitted in a fixed way by any appropriate means such as those previously described.

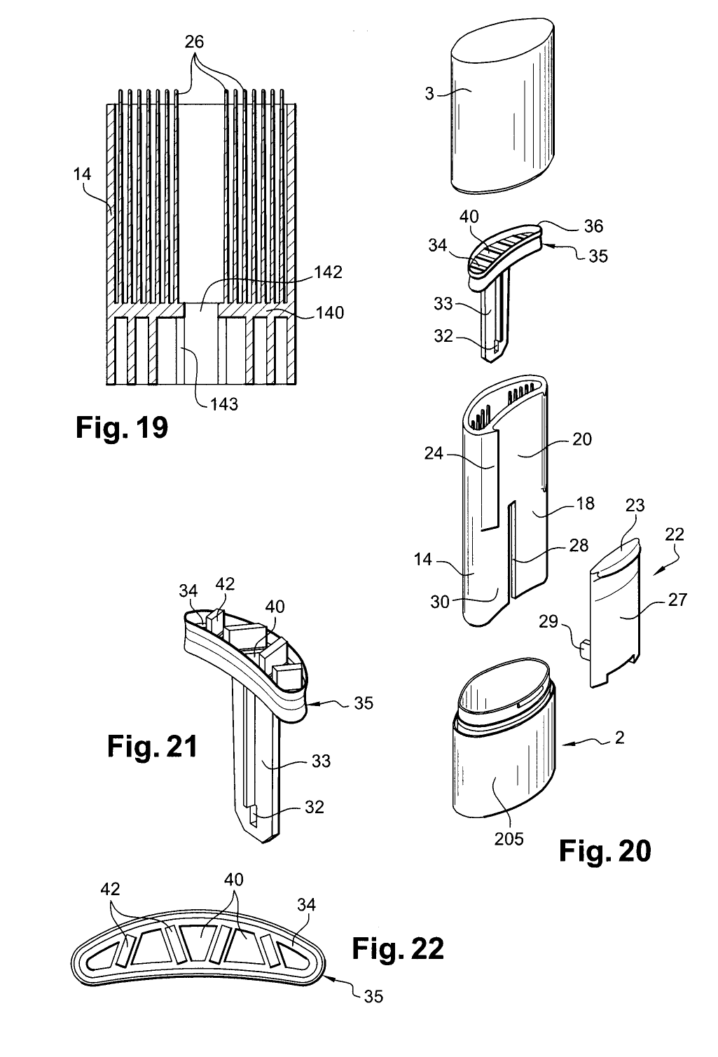

In the present example embodiment, the shaft may have an approximately central part without projecting elements so as to allow, as illustrated in FIG. 20, insertion of the product support. Elements restricting movement, and in particular centering elements 142, can be employed to simplify mounting of the product support. Such elements can extend facing the central portion. They can in particular form a guide rail for the mounting of the support. Such a guide rail can, for example, include at least one longitudinal rib. As can be seen in the example illustrated in FIG. 19, this guide rail may more precisely include a pair of longitudinal ribs 143. If necessary, a second pair of ribs positioned facing the first pair may be provided.

In another example, the projecting elements 26 can extend on both sides of this central portion. It is therefore possible to distinguish two different groups of projecting elements, each including a plurality of projecting elements, each group being able to have, for example, between 2 and 20 projecting elements. The two groups can include projecting elements 26 that are identical in number, nature and/or configuration. By contrast, the number, nature and/or configuration of these projecting elements 26 can be different. Such an embodiment can then enable a different making-up or treatment of keratinous fibers depending on the group of projecting elements chosen.

As can be seen in the example illustrated in FIGS. 5 and 6, the push button 23 includes an outline and/or a surface effect that facilitates its handling. In particular, the push button includes a recess configured in order to cooperate with the pad at the end of the thumb. The lateral wall 18 includes guide rails 24 for cooperating with the push button 23. In the example illustrated in FIG. 4, the push button is in a mid position between a free border of the second internal skirt 11 and the dispenser opening, and the product, presented here in the form of a solid tablet, is mounted partly outside the dispenser opening 15.

The push button 23 is mobile relative to the shaft 14 between a low position and a high position. In the low position a free axial end of the push button, relative to its axis of translation X, passes beyond the base unit 2 and is situated close to the free border of the second internal skirt 11. Conversely, in the high position the free axial end is positioned approximately in the plane of the dispenser opening 15 and more particularly at the level of the free edge 25 of the lateral wall 18 of the shaft 14. The push button 23 includes a wall forming a screen 27 which progressively emerges from the base unit when the push button is brought from the low position to the high position. This screen 27 is initially concealed in the base unit 2 in the low position. This screen 27 includes, as is visible in the exploded views of the example illustrated in FIGS. 5 and 6, a spur 29 raised transverse to this screen at the level of a free end opposite the free end of the push button which is configured to be handled. Even in the high position the push button may extend to a lower height than the free end of the projecting elements. The spur is configured to pass through a groove 28 formed in an axial portion 30 of the lateral wall 18. For example, the groove 28 is formed in the outwardly concave face 20. The groove 28 guides the sliding of the push button along the shaft 14.

Advantageously, the groove 28 is formed in the portion of the shaft 14 contained in the base unit. It is concealed both by the base unit and the push button 23, in particular the screen 27 of the push button 23. The groove 28 opens out at an axial end opposite that defining the dispenser opening 15. Thus the spur 29 may be inserted in the groove 28 by translation along the groove 28. The spur 29 includes one end 31 engaged in an orifice 32 formed in a shank 33. This shank 33 may stand out from a base 34 with openings of the plate 35 on which the product is positioned. The shank 33 stands out in a direction opposite the movement of the plate from the low position to the high position along the X axis. The end 31 may be snap-fitted or tight-fitted. Alternatively, given the confinement of the push button and of the plate in relation to the shaft, the engagement may be flexible, as the only movement tolerated is axial along the X axis.

In an example variant, the push button 23 and the plate 35 may be produced in a single piece. This piece can be U-shaped, including a connecting arm at the product support, a bar projecting outside the device through the groove 28 and the thumbwheel, for example, opposite the outwardly concave portion 20 in the present example. Such a piece can be inserted into the groove 28 by translation along the groove 28.

Returning to the previous example, the shank 33 is situated, inside the shaft, in the portion concealed by the base unit 2 when the push button 23 is in the low position. The groove 28 and the base 9 cooperate to form a first stop B1 (see, for example, FIG. 8) for translation of the push button relative to the shaft. The low position is thus determined.

It is possible, in this low position, to provide for the plate 35 to be in sealed engagement with the internal circumference of the shaft 14. In this example, the external circumference of the plate has a circumference slightly larger than the cross section of the internal circumference of the lateral wall 18 so as to lead to sealed fitting. Conversely, dynamic sealing is preferably not provided between the plate and the internal circumference of the shaft when the plate is translationally driven inside the shaft 14. This is because the internal circumference of the lateral wall is slightly flared in the direction of its dispenser opening 15.

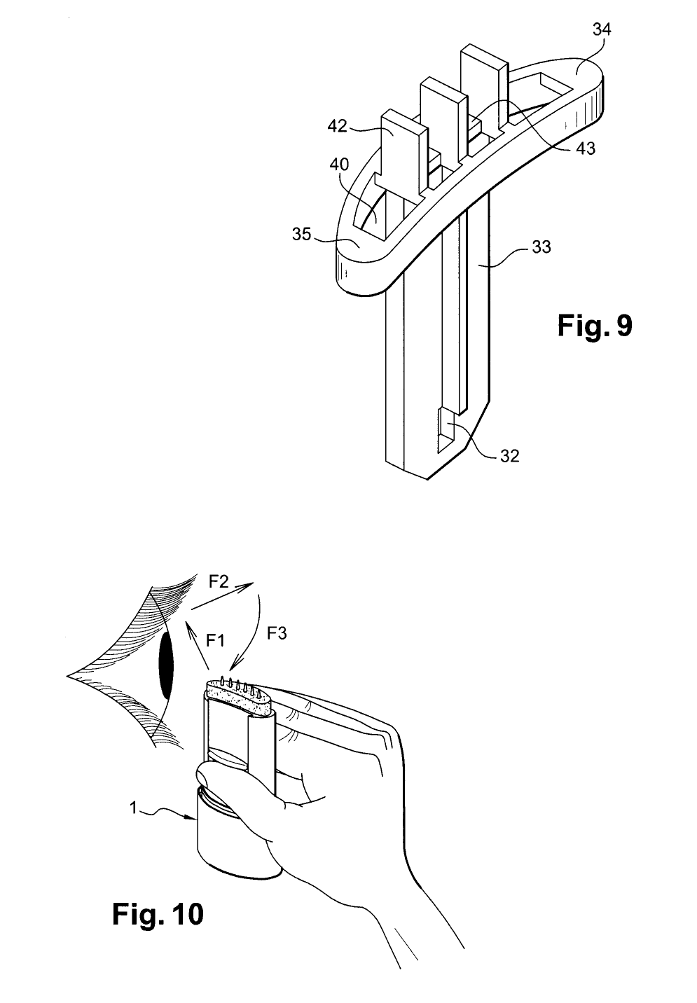

The plate 35 includes an annular lip 36 in order to delimit the seat intended to receive the product to be distributed. This annular lip 36 may come into elastic sealed contact with the internal circumference of the lateral wall, in particular in the low position. Such a plate 35 can also include a plurality of cross-members 42 (see, for example, FIG. 9) connecting two opposite portions of the base 34. Such a structure improves the anchoring of the product on its support. The number of such cross-members may, for example, be three. Fins can stand up from these cross-members. Such fins can therefore project relative to the base 34. These fins can optionally stand up approximately parallel to each other. A stiffening means 43 for stiffening this support, for example in the form of a beam, can connect these cross-members. If appropriate, openings may be left on both sides of this beam, between the beam and the base 34. According to an example variant shown in FIGS. 21 and 22, the number of these fins may, for example, be four. They may be arranged so that two adjacent fins extend in respective cutting planes. In particular, these fins may define an acute angle, for example of around 25°, between them. Furthermore, a first and a third fin may extend parallel to one another, the same as a second and fourth fin. Such an arrangement ensures good anchoring of the product on its support.

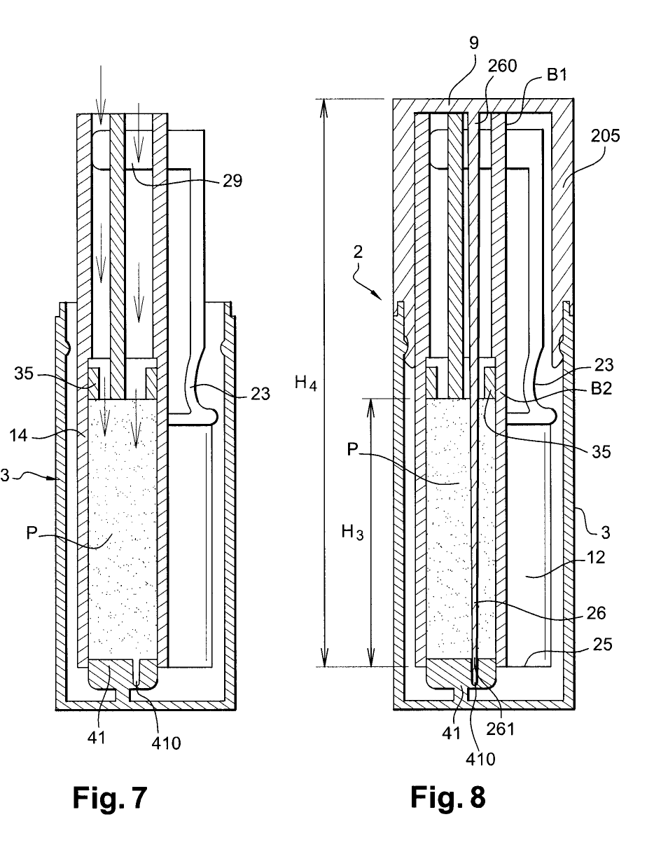

As can be seen in FIG. 8, for example, the groove 28 includes a second stop B2 axially opposite the first stop B1, this second stop being situated below the level of the annular lip 36 when the push button is in the low position. As a result the height of the product H3 before first use may correspond to the distance between the plate 35 in the low position and the plane of the free edge 25. This height H3 is, for example, around 3 cm. The total height H4 between the base 9 of the base unit and the free edge 25 of the shaft 14 when the latter is mounted is approximately equal to twice the height H3, for example. The ratio R of the height H3 to the height H4 is around 0.5, for example, as shown in FIGS. 7 and 8.

In the example illustrated in FIGS. 7 to 9 it can be observed that the openings or orifices 40 provided in the base 34 in order to make it permeable to the product enable filling with the product through the base, as the base unit 2 is not then positioned around the shaft. In order to fill the devices according to the example embodiment of FIGS. 7 and 8, the upper lip of the plate 35 is constrained in the shaft 14 so as to prevents the push button from sliding through gravity in the direction of its high position. The cap 3 is put on. An obturator 41 is also provided, arranged inside the shaft in order to block the housing and shape the free end of the product hot-poured into its housing. The obturator 41 includes a gripping means passing into the cap in order to facilitate its removal during the first use. The obturator 41 can be produced in a single piece with the cap 3 or be connected in a fixed manner in this cap 3.

The cap 3, and if appropriate the obturator 41, can include positioning means 410 for positioning the projecting elements. Such means are particularly useful for correctly positioning the projecting elements while filling the device with the product. They can include a plurality of housings capable of at least partly receiving the projecting elements, and in particular their respective free end. These housings can enable these free ends to be kept out of contact with the product when the latter is poured. The projecting elements will thus be able to be in a projecting configuration relative to the product during pouring and at the end of pouring.

In an example variant, or additionally, a separate element provided with the positioning means 410 can be provided. This element can be connected to the cap. It can, for example, include a plate, if necessary a flexible one, or a foam. This element can be locally perforated so as to form a plurality of housings for the projecting elements. Such a separate element can then extend between an internal wall of the cap and the poured product.

The distance between the two stops B1 and B2, reduced by the axial height of the spur 29 in the groove 28, defines the tolerated axial travel of the plate 35 in the shaft and corresponds approximately to the distance between the low position and the high position. Advantageously, when the push button is in the high position, the end of the fins of the plate 35 is located approximately at the level of the dispenser opening 15.

In an example variant, not shown, a member permeable to the product may be positioned at the level of the dispenser opening 15. This permeable member may be porous, fibrous, cellular, or alternatively drilled with several channels. Thus the flow rate and the distribution of the product at the opening may be modified. A more liquid formula can be distributed in this way. In this example, the plate is provided in order to be in sealed contact with the shaft 14 over the entire height between the low position and the high position.

Additionally, the free edge 25 may also include separation/combing elements 26.

The gripping element 2, the cap 3, the shaft 14, the push button 23 and the plate 35 are, for example, obtained by moulding. They are, for example, respectively made of polyethylene, polypropylene, polyamides, polyacetal, polystyrene, polyoxymethylene (POM), ABS, etc. The plate 35 and the shaft 14 are preferably not made of the same material in order to avoid friction between two parts with the same coefficient of friction. Thus the movement of the plate 35 relative to the shaft 14 can be smooth and without causing a creaking noise.

As is shown in the example illustrated in FIG. 10, the device 1 according to the invention is particularly configured for the application of a pasty product on the eyelashes. This device is innovative for the users, as are the body movements in use. Specifically, the use of such a device preferably occurs by bringing the device into contact with the base of the eyelashes, presenting the major axis Y approximately tangentially to the cornea, the path the user imposes on the device to obtain the desired coating of her eyelashes following a loop according to a movement whose components are defined in a plane perpendicular to the cornea and parallel to the ridge of the nose. This movement breaks down into three stages and corresponds to the movements F1, F2 and F3 shown diagrammatically in FIG. 10.

According to this application body movement, the user preferably presents the curve C defined by the dispenser opening 15 approximately parallel to the curve formed by the free edge of the eyelid at which level the eyelashes are implanted. Advantageously, the rims defined at the junction between the portions 16 and 17 respectively enable improved treatment of the edges of a row of eyelashes, in particular for the coating of eyelashes of the internal and external edge of the eye, including occasional retouching. In this example, the movements of the device are still carried out in the plane perpendicular to the cornea and parallel to the ridge of the nose, but in this case the major axis Y is positioned in this plane.

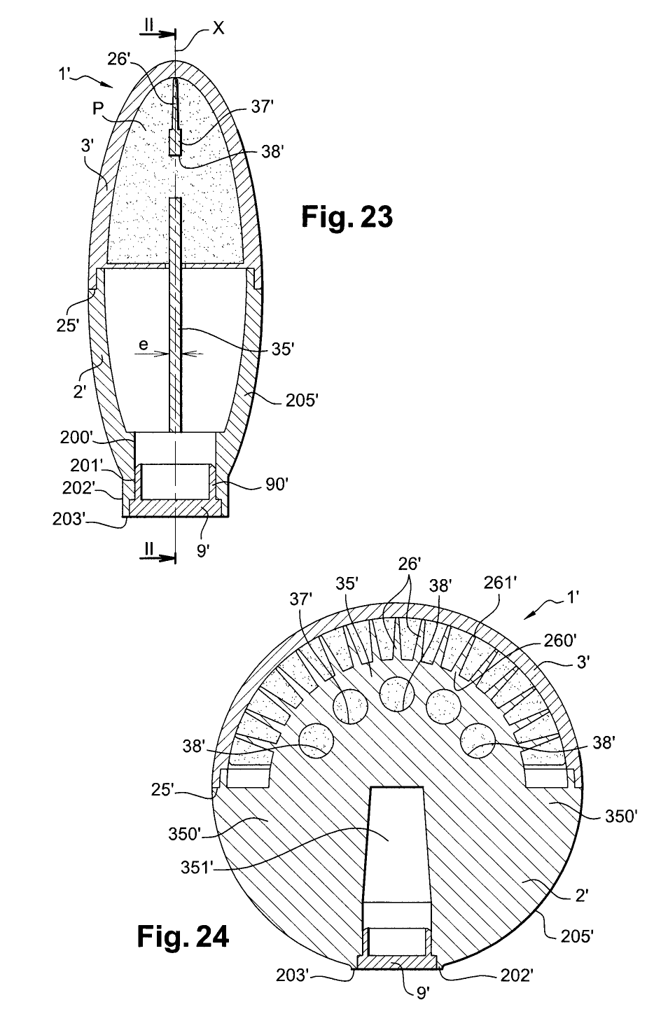

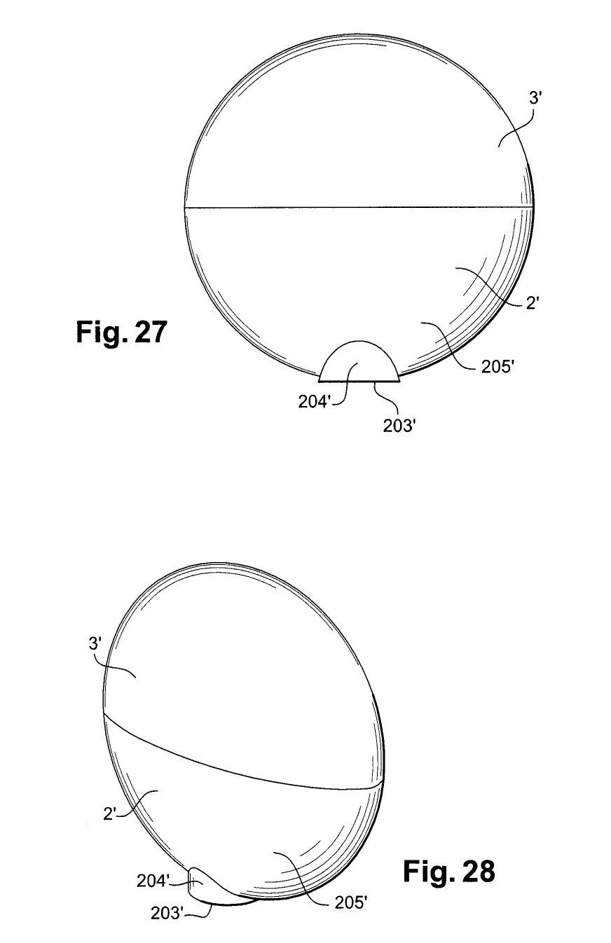

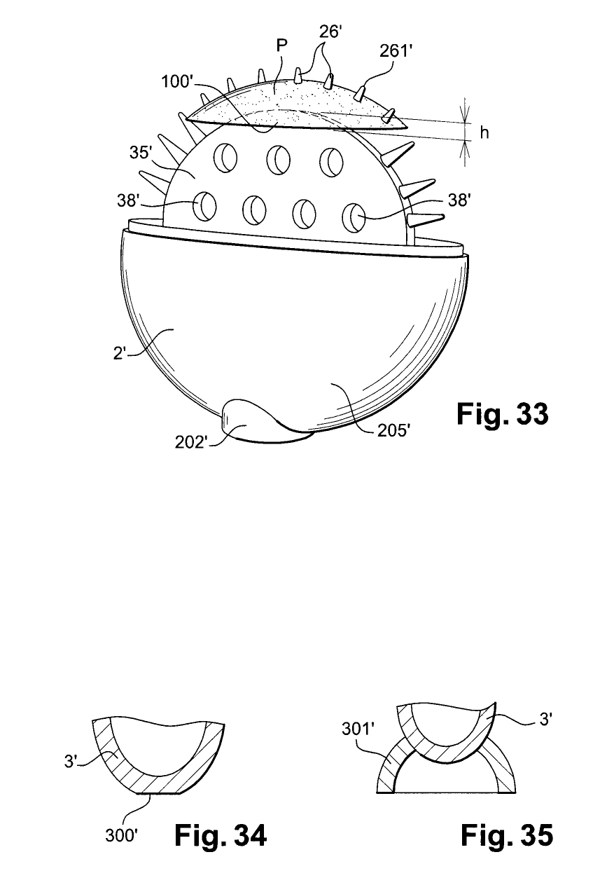

FIGS. 23 to 38 show a second example embodiment of a device 1′ for packaging and applying at least one cosmetic product, including care products, on keratinous fibers. Only the elements of the second example embodiment differing from elements of the first example embodiment will be described. Similar references, with a prime sign added, have been allocated to elements of the second example embodiment which are similar to the elements of the first embodiment.

This second example embodiment differs in particular from the first example embodiment in that the gripping element and the shaft are only one part and in that it lacks a driving means and in particular a push button. Moreover, the product support denoted a plate in referring to the first example embodiment will be called the internal frame in this second embodiment.

The packaging and application device 1′ shown in FIGS. 23 to 38 includes a base unit 2′ on which a protective cap 3′ can be attached. The base unit 2′ includes a gripping element 205′ which the user can grasp. In the present example, the gripping element 205′ includes a filling opening 200′ situated on the side opposite the cap 3′, blocked by a base or blocking member 9′. The device 1′ also includes an internal frame 35′, optionally fixed in relation to the gripping element 205′. This frame, for example, comes from molding in a single piece with the gripping element 205′, for example from a thermoplastic material.

The attaching of the cap 3′ on the gripping element 205′ of the base unit 2′ can be carried out in various ways, for example by friction or snap-fitting, or even by screwing if the shape of the cap permits it. The frame 35′ may be without contact with the cap 3′ when the latter is in place. The base 9′ may also be attached in various ways on the gripping element 205′, for example by friction, snap-fitting or screwing. The base 9′ can be removable or non-removable.

In the present example, the base 9′ is removable and includes an annular sealing lip 90′ which is applied in a sealing manner to a cylindrical surface of revolution 201′ of the filling opening 200′. The frame 35′ aims to hold the product mechanically, which allows new possibilities in terms of formulation, and in particular enables the use of a relatively fragile product without worrying that the product will break on use. Such a frame can thus be fixed relative to the product and extend into the latter. The frame 35′ can be flat or not flat, for example cylindrical or rippled. A flat shape can provide the frame with flexibility, if appropriate. In the example illustrated in FIG. 23, the frame 35′ has a flat shape with a thickness e that may, for example, decrease slightly in the direction of its upper rim or edge 37′ which may have an approximately semicircular shape in front elevation.

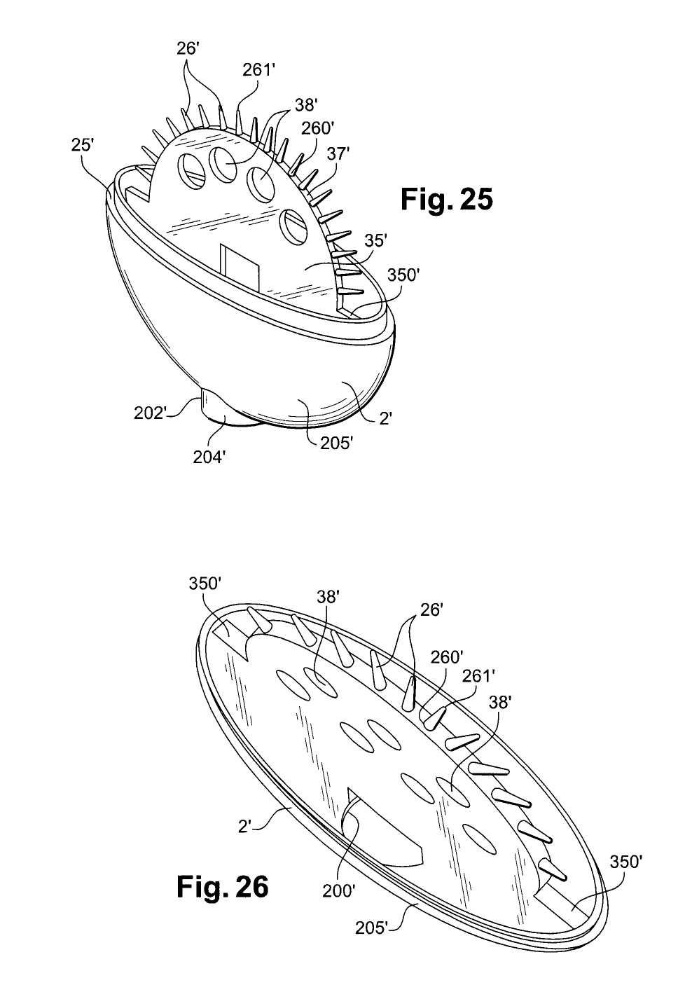

The gripping element 205′ can include a free rim or edge 25′, optionally extended by a shoulder to enable the cap 3′ to be inscribed in the continuation of the external surface of the gripping element 205′. In the present example, the gripping element 205′ has, over at least part of its height, an external cross section of oblong shape, in particular approximately elliptical shape, as can be seen in FIGS. 25 and 26, for example.

The frame 35′ can be fitted to the gripping element 205′ by diametrically opposite stays 350′, the frame 35′ being, in the present example, flattened in a plane containing the major axis of the cross section of the base unit 2′. The frame 35′ can include a recess 351′ at its base part, as illustrated in FIG. 24, in line with the filling opening. In the present example, the frame 35′ includes openings, including a plurality of holes 38′ possibly passed through by the product so as to improve the anchoring of a product stick P on the frame 35′. In a variant, or additionally, the frame 35′ can include reliefs encouraging the fixing of the product on the frame.

According to the present example of the invention, and as can be seen in the example illustrated in FIG. 25, the projecting elements supported by the frame 35′ are inscribed in the dispenser opening 15′ defined by the free rim 25′. In addition, these elements extend a distance from this free rim. In particular, these projecting elements are arranged on an edge 37′ of the frame 35′. This edge 37′ is able to define a curved anchoring surface for the projecting elements, for example in a semicircle. Such elements may be produced in a single piece with this frame. In an example variant, they may be fitted on this frame and attached by any appropriate means.

As shown in the example illustrate in FIG. 25, the projecting elements 26′ can include at least one row of teeth arranged in a curved profile. These projecting elements 26′ can, for example, extend over at least a quarter of a circle, preferably a third of a circle or even a half circle. Such projecting elements may extend radially relative to the frame 35′. Such projecting elements 26′ may thus point in respectively different directions. These projecting elements 26′ may in particular extend in a plane extending the device 1′.

According to an example variant shown in FIG. 38, the projecting elements 26′ can include at least one row of teeth whose free ends 261′ extend to the same height. Such free ends can be arranged in a straight profile. To do this, at least some, or even all, of the projecting elements 26′ may have a different length. In particular, the projecting elements 26′ at the centre or at the peak of the edge 37′ can have a shorter length than the peripheral teeth. For example, this length can decrease from the centre, or peak, of the frame towards the periphery of this frame. The projecting elements can thus be increasingly large as the free rim 25′ is approached. Such projecting elements can point in the same direction. In other words, these projecting elements 26′ can extend approximately parallel in relation to each other.

As is visible in the examples illustrated in FIGS. 24 and 38, the projecting elements 26′ extend at least partly into the product stick. More precisely, these projecting elements 26′ include respective free ends 261′ suited to be flush with or, in this example, to project relative to the free external surface 100′ of the product. In the present example, the stick P extends below the base unit 2′ inside the cap 3′, but it remains within the scope of the present invention when the product stick P also extends to the inside of the base unit 2′, and in particular of the gripping element 205′, at least before the first use of the device 1.

The filling opening 200′ may be formed inside a base part 202′ of the gripping element 205′, having a lower end 203′ situated in the same plane perpendicular to the longitudinal axis of the device 1, which enables the user to stand it on a plane horizontal surface. The base part 202′ has, for example, a cylindrical external surface of revolution 204′ about the X axis, as can be seen in FIG. 25.

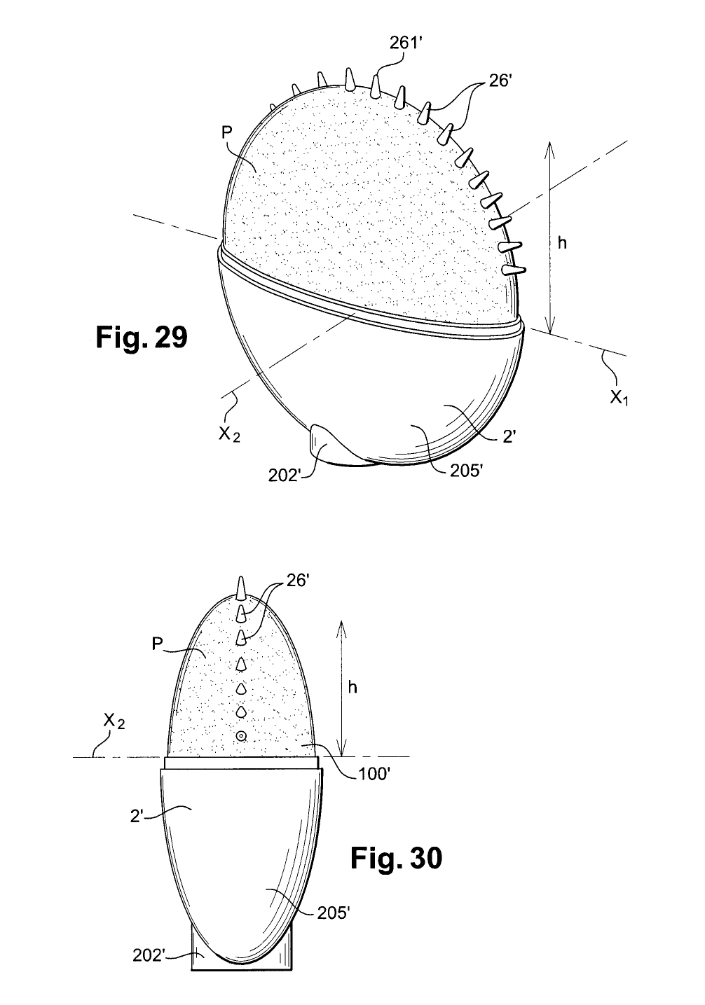

As can be seen in FIG. 29, the product stick P may have various shapes and, for example, an oblong cross section extended on a major axis X1. The dimension d1 of the stick P along the axis X1 can be, for example, such that the ratio d1/d2, where d2 denotes the dimension along the minor axis X2 perpendicular to X1, is between 4 and 1, this range of values of course being in no way limiting.

The product stick P can define a free external surface 100′ extending over at least part of the height of the frame. This surface can be arranged so as not to make contact with a wall covering it during use of the device. In other words, the product stick P covers the frame 35′ over a height h while having a free external surface 100′ during use which is able to vary according to the wear of the product stick. Thus the product may be applied without any limitation other than removing the protective cap.

The product or products can be intended for application on keratinous fibers. This product may be poured into the device through the filling opening 200′, the base 9′ being removed and the cap being in place on the base unit 2′, the device 1′ being upside down. Filling with the cap 3′ in place is suitable when the adhesion of the product to the cap 3′ is weak enough to avoid damage to the product stick P when the cap 3′ is first removed. The cap 3′ may optionally be made of a material that reduces the adhesion of the product or may have undergone surface treatment that produces the same effect.

The cap 3′ can include positioning means that includes, for example, a plurality of housings or recesses into which the projecting elements can extend, in particular during the pouring of the product. In an example variant, a separate element, such as a flexible plate or a foam provided with the positioning means may be used. In an example variant, the product is poured into a mould above which the base unit 2′ is positioned upside down, for example a mould made of silicone or any other material allowing the product stick P to be removed from the mould without damage.

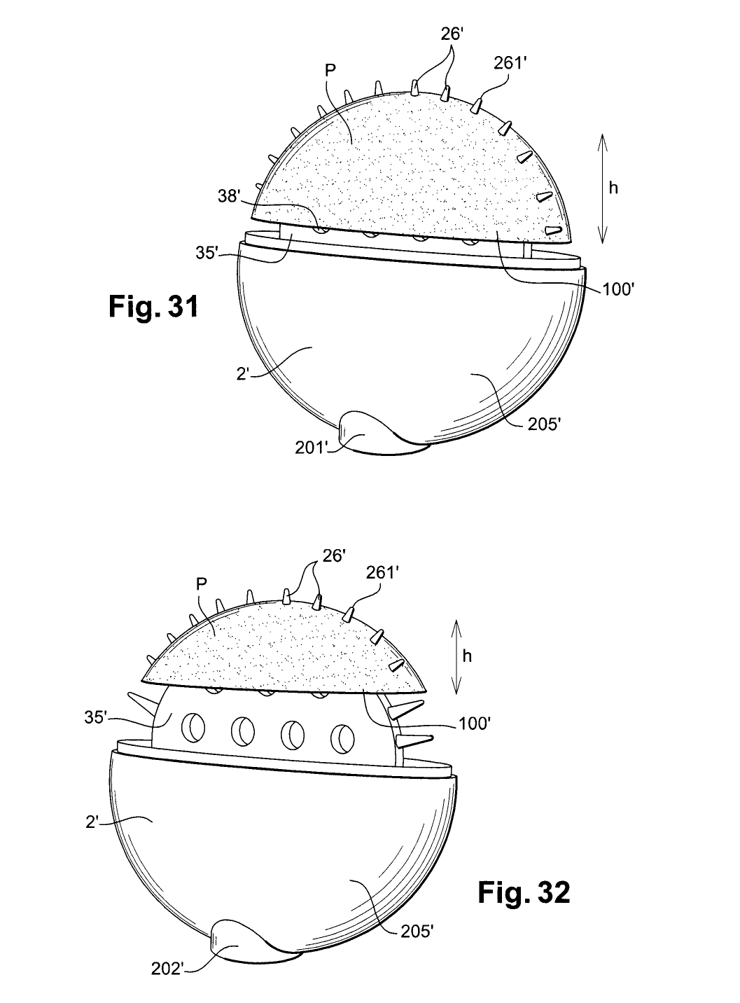

The product can be formulated so as to be easily fluidized. This can allow the user to reshape the application surface after consuming part of the product, by positioning the device 1′ upside down and by exposing the product, with the cap in place, to a heat source, for example inside a microwave oven. So as to remain upside down during fluidization of the product, the cap 3′ may be made, as shown in FIG. 34, with a flattened peak 300′. The cap is thus arranged in order to rest in a stable manner upside down on a plane horizontal surface. This can facilitate reshaping of the product stick. In an example variant, as illustrated in FIG. 35, a stand 301′ can be used, this stand 61 being arranged to keep the device 1′ vertical with the cap at the base. The reshaping of the application surface makes it possible to have a product stick P matching the shape of the interior surface of the cap as the product is consumed, as illustrated in FIGS. 31 to 33.

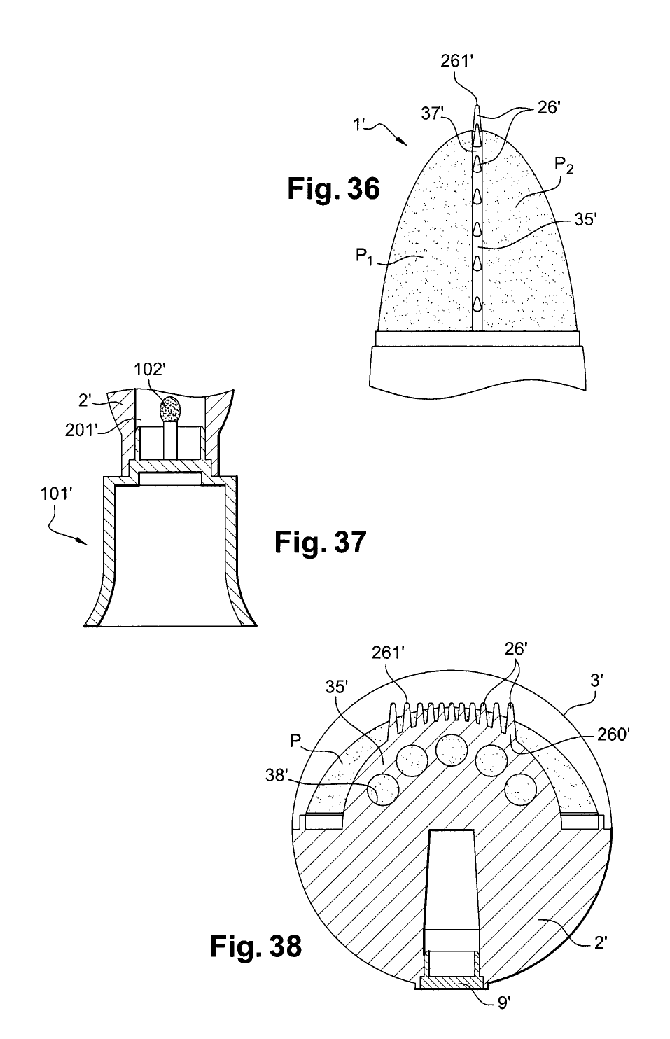

In the example variant illustrated in FIG. 36, the device 1′ includes a product stick including two different products P1 and P2, each occupying, for example, approximately half of the stick. The two products can be respectively arranged on both sides of a mid-plane for the frame. One of the products can be colored and the other intended to add sheen; the two products can be applied one after the other, for example. The frame 35′ can be identical to that of the previously described example.

The product can, if appropriate, be poured by the user herself into the device, this product being, for example, produced from one or more components that are mixed in the chosen proportions by the user depending on the result sought. The positioning means provided for accommodating the projecting elements may be of a length such that the internal wall of the cap, or of the separate element, is able to stop against the edge 37′ when the cap 3′ is placed on the base unit 2′, and this in such a way as to avoid the products P1 and P2 mixing. In such an example, the cap or the separate element serve as a member separating the poured products.

The device may optionally include, as illustrated in FIG. 37, an applicator 101′, that serves for example as a corking member. The applicator 101′ possibly including an application member 102′ which is housed in the base unit 2′ when not being used. In this example, this application member can be received in a housing formed in the gripping element 205′. The application member 102′ can, for example, be used to carry out finishing operations and can include a felt point, a flocked tip, a small brush, a foam, a larger brush, a comb etc. In an example variant, the application member 102′ includes or is loaded with a different product from that housed in the cap 3′, in order, for example, to draw an outline or provide an additional optical effect.

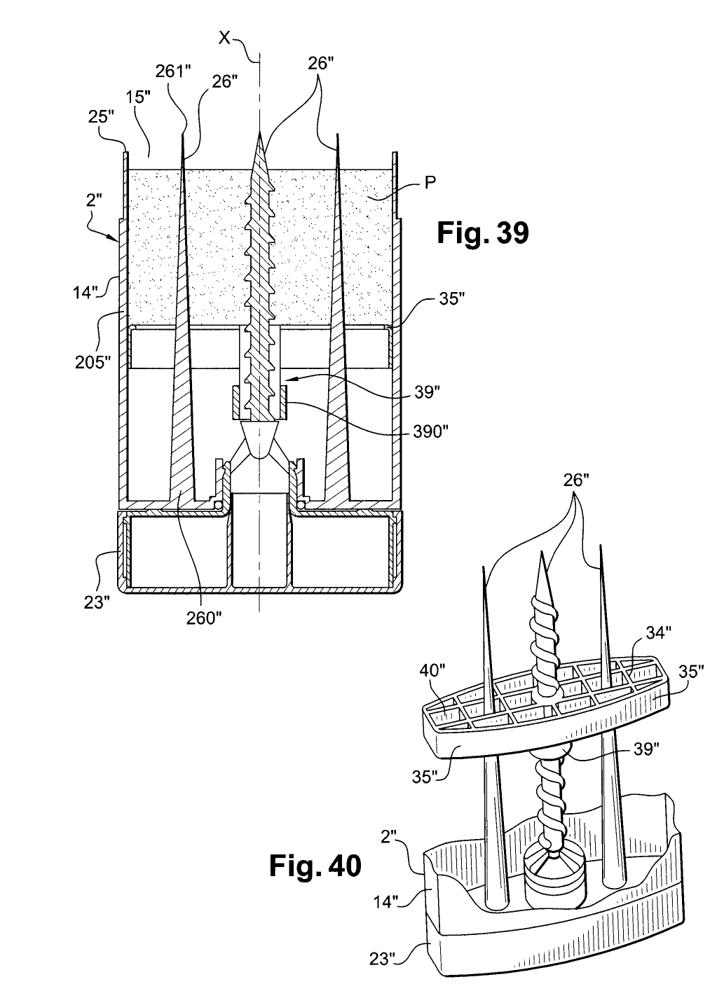

FIGS. 39 and 40 represent a example third embodiment of a device 1″ for packaging and applying at least one cosmetic product, including care products, on keratinous fibers. Only the elements of the third embodiment that differ from elements of the first example embodiment will be described. Similar references, with a second sign added, have been allocated to elements of the third example embodiment similar to the elements of the first example embodiment.

This third example embodiment differs in particular from the first example embodiment in that the device 1″ includes a driving means 22″ that includes a thumbwheel 23″ mounted to rotate on the shaft 14″. In this example, apart from the thumbwheel 23″, the shaft 14″ can be used as a gripping element 205″ during rotation of the thumbwheel 23″. One hand of the user can then engage the thumbwheel 23″ and her other hand may come into contact with the shaft 14″ so as to keep it stationary during the rotation applied to the thumbwheel. The thumbwheel 23″ can be joined to a threaded rod or screw. The rod is engaged with the product. It can also form a projecting element 26′ by extending in this way through the dispenser opening 15″. It can then occupy a projecting position relative to the free rim 25″ and relative to the free external surface 100″ of the product. This projecting element can thus be joined, in particular in rotation, to the thumbwheel 23″. Projecting elements 26″ can also stand up from the shaft 14″ of the base unit 2″.

The product support 35″ can include a plate supporting a product stick P. These elements then pass through the openings 40″ in the plate 35″ and the product P. A connecting member 39″ supporting the plate 35″ can also be provided. In particular, this member can connect the rod 26″ and the plate 35″. This member can include a sleeve 390″ covered on the inside with a thread designed to cooperate with the complementary thread of the rod 26″. Such a member is then designed to convert a rotational movement of the rod 26″ applied to the thumbwheel 23″ into an axial movement of the plate 35″ and hence of the product P relative to the shaft 14″. The structure and the mode of operation of such a device are described further in the document FR-2 750 022, the content of which is here incorporated by way of a specific reference.

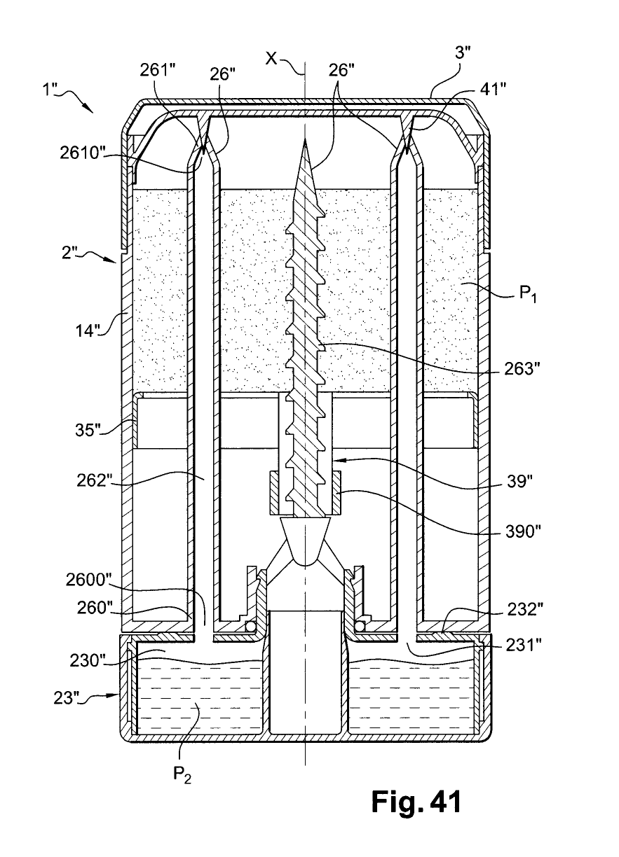

FIG. 41 shows an example variant of the third embodiment of the packaging and application device according to the present invention. In such a case the device can include two distinct product housings receiving identical or different products P1 and P2. As well as products of different composition, the term “different” includes products of identical composition but of different consistency. For example, the product P1 can be a product in stick form while the product P2 may be a liquid product.

A second product housing 230″ can, for example, be provided in the thumbwheel 23″. Such a housing can be annular. In this example embodiment, the thumbwheel 23″ can include a product outlet orifice 231″.

The projecting elements 26″ may in turn be passed through internally by a product dispenser channel 262″. The product dispenser channel 262″ may extend along an axis of extension of the projecting elements. In other words, this channel can extend from the base part 260″ of the projecting elements through to the free end 261″ of these projecting elements. The base part 260″ then includes a product inlet orifice 2600″ designed to be placed in fluid communication with the outlet orifice 231″ of the thumbwheel while the free end 261″ includes a product dispenser orifice 2610″.

A cap 3″ including an obturator 41″ may be provided so as to be positioned mounted on the base unit 2″ in a position blocking the dispenser orifice 2610″. To do this, the obturator 41″ can include protuberances capable of covering or being inserted into the respective dispenser orifices 2610″. Such protuberances can also serve as means for positioning the projecting elements 26″ during pouring of the product. In this nonlimiting exemplary embodiment these protuberances extend from a separate element in the cap 3″.

Marking means can be provided, for example, on the thumbwheel 23″ and/or on the shaft 14″ in order to identify to the user what degree of rotation should be applied to the thumbwheel 23″ in order to place the product outlet orifice 231″ of the thumbwheel opposite the inlet orifice 2600″ of at least one of the projecting elements. These marking means can, for example, include visual indications such as lines or pictograms, provided on the thumbwheel 23″ and the shaft 14″ respectively, to be placed opposite each other (not shown). In an example variant, or additionally, these marking means can include nipples 232″, provided, for example, on one wall of the thumbwheel facing the shaft, capable of cooperating with corresponding recesses formed in the shaft, or vice versa. In an example variant, or additionally, these marking means can be connected to the configuration of the device. For example, the device may have a cross section of elongate shape, such as oval or elliptical. In this case, the product outlet orifices 231″ and the product inlet orifices 2600″ may communicate in a fluid manner when the thumbwheel 23″ and the shaft 14″ have a similar orientation so that their external walls extend continuously from one to the other. For example, the device may pass from a position of communication of the orifices to a position of non-communication of the orifices when the thumbwheel 23″ is turned through 180° relative to the shaft 14″ and vice versa.

In such an example, the dispenser opening 15″ extends over a surface strictly greater than that defined by the dispenser orifice 2610″, in particular at least twice, five times, ten times, one hundred times or more as great, for example.

So as to allow distribution of the product P2, the thumbwheel 23″ can include a flexible wall capable of being compressed by the user so as to cause the product P2 to climb through the dispenser channel 262″.

In an example variant, a driving means or driving arrangement of the piston type can be employed (not shown). This driving means or driving arrangement can include a plate forming an end wall of the product housing 230″. Such a plate can be mounted in sealed frictional contact in the thumbwheel 23″. With each movement of this plate in the direction of the product outlet orifices 231″, through sliding or screwing for example, the product P2 may be distributed through the dispenser orifices 2610″. In an example variant, the product P2 can be distributed by the effect of gravity by upending the device 1″. In these various exemplary embodiments it is possible to apply the products P1 and P2 alternately or simultaneously.

The invention is not limited to the exemplary embodiments that have just been described. Specifically, for example, it is also possible to provide projecting elements according to the invention within other conventional mechanisms for dispenser products in stick form and/or inside other stick forms.

In the entire description, the expression “comprising”, “having” “including” or “includes” “has” should be considered to be synonymous with “comprising at least one” or “including at least one” unless specified to the contrary. Similarly, expressions such as “comprising two” should be interpreted as meaning “at least two” unless otherwise stated.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A device for packaging and applying a product over a bodily application surface comprising:
a dispenser opening, and
projecting elements that are distinct from the product,
wherein said projecting elements extend into said dispenser opening and are positioned at a distance from a rim that delimits said dispenser opening.

2. A device according to claim 1, further comprising a base unit, wherein said projecting elements are joined to said base unit.

3. A device according to claim 2, wherein said projecting elements are fixed relative to said base unit.

4. A device according to claim 1, wherein said projecting elements are arranged in said device so as to ensure combing of the bodily application surface from a first use of the product.

5. A device according to claim 1, wherein said projecting elements are arranged in said device so as to ensure combing of the bodily application surface through approximately the entire lifetime of the product.

6. A device according to claim 1, wherein said projecting elements and said product project relative to the rim that delimits the dispenser opening.

7. A device according to claim 1,wherein the product defines a free external surface that surrounds said projecting elements and that is suited to being brought into direct contact with the application surface.

8. A device according to claim 1, wherein the product defines a free external surface that projects relative to the dispenser opening.

9. A device according to claim 1, wherein said projecting elements comprise a first end associated with said base unit and a second free end, said first and second ends being connected to each other via an intermediate portion that extends at least partly into the product.

10. A device according to claim 1, wherein said projecting elements pass through the product at two opposite portions of the product.

11. A device according to claim 1, wherein said projecting elements project relative to an upper portion of the product intended to come into contact with a bodily surface.

12. A device according to claim 1, wherein at least part of the projecting elements extends to an invariable height relative to the dispenser opening.

13. A device according to claim 1, wherein said projecting elements extend from or through a product support.

14. A device according to claim 1, wherein which said projecting elements are arranged in a row of generally straight or curvilinear profile.

15. A device according to claim 1, wherein the product is in stick form.

16. A device according to claim 1, wherein the product is a cosmetic product.

17. A device for packaging a product, comprising:
a base unit that extends from a base of the device to a free rim that defines an opening in the base unit;
a product support arranged within the base unit; and
a plurality of elongated elements that are mounted on the base unit and that project beyond the product support,
wherein the plurality of elongated elements are connected to said base unit so as to extend above the opening in the base unit and so as to be spaced from the free rim.

18. A device according to claim 17, wherein said plurality of elongated elements are fixed relative to said base unit.

19. A device according to claim 17, wherein the product defines a free external surface that surrounds said plurality of elongated elements.

20. A device according to claim 19, wherein the free external surface projects relative to the opening in the base unit.

21. A device according to claim 17, wherein said plurality of elongated elements each include a first end associated with said base unit and a second free end, said first and second ends being connected to each other via an intermediate portion that extends at least partly through the product.

22. A device according to claim 18, wherein said plurality of elongated elements each extend through the product so as to pass through a first surface on a bottom portion of the product and second surface on a top portion of the product that defines a free external surface of the product.

23. A device according to claim 17, wherein said plurality of elongated elements project relative to a free external surface of the product that is located on an upper portion of the product.

24. A device according to claim 17, wherein the product support is a frame that is fixed relative to the base unit.

25. A device according to claim 24, wherein the frame supports two different products.

26. A device according to claim 17, wherein the product support is mounted on the base unit so as to be movable relative to the base unit.

27. A device according to claim 26, wherein the plurality of elongated elements are fixed relative to the base unit.

28. A device according to claim 17, wherein the base unit includes two distinct product housings that respectively receive a first product and a second product.

29. A device according to claim 28, wherein the first product and the second product are of identical composition and of different consistency.

30. A device according to claim 28, wherein each of said plurality of elongated elements includes a first end associated with said base unit and a second free end, said first and second ends being connected to each other via an intermediate portion, and wherein at least one of the plurality of elongated elements includes a product dispenser channel that opens into the second product housing at the first end of the at least one of the plurality of elongated elements, extends axially through the intermediate portion of the at least one of the plurality of elongated elements and opens at the second free end of the at least one of the plurality of elongated elements.

31. A device according to claim 30, wherein said intermediate portion of the at least one of the plurality of elongated elements extends at least partly through the first product housing.

32. A device according to claim 17, wherein the product is a cosmetic product.
